(19) United States
(12) Patent Application Publication
(10) Pub. No.: US 2013/0062172 A1
(43) Pub. Date: Mar. 14, 2013

(54) Circuit Breaker Trip Unit With Displaying Device

(71) Applicants: Randal Paul Shvach, Conway, PA (US); John Anthony Massoud, Aliquippa, PA (US); James Leo Lagree, Robinson Township, PA (US)

(72) Inventors: Randal Paul Shvach, Conway, PA (US); John Anthony Massoud, Aliquippa, PA (US); James Leo Lagree, Robinson Township, PA (US)

(21) Appl. No.: 13/228,205

(22) Filed: Sep. 8, 2011

(51) Int. Cl. H01H 9/00

(52) U.S. Cl. 200/308

(57) ABSTRACT

Provided herein is a circuit breaker trip unit with a displaying device. The displaying device has a first displaying region, a second displaying region and optionally a third displaying region. The first displaying region is adapted to show one or more icons alone or together with text arranged in horizontal lines; the second displaying region is adapted to show text arranged in horizontal lines or graphics; the third displaying region is adapted to show text arranged in a horizontal line.

### FIELD

The present disclosure relates to circuit breaker trip units with a displaying device.

### SUMMARY

Provided herein, is a trip unit for a circuit breaker with a displaying device. According to an aspect of the present disclosure, the displaying device comprises a first displaying region adapted to show a plurality of displaying conditions related to the circuit breaker. The displaying conditions include a first condition where a plurality of user-selectable icons related to the circuit breaker is shown, and a second condition where a selected icon from the plurality of user-selectable icons and text are shown, the text being contextually related to the selected icon. The displaying device also comprises a second displaying region adapted to show text or graphics contextually related to the selected icon.

The details of one or more embodiments of the disclosure are set forth in the accompanying drawings and the description below. Other features, objects, and advantages will be apparent from the description and drawings, and from the claims.

### BRIEF DESCRIPTION OF THE DRAWINGS

The accompanying drawings, which are incorporated into and constitute a part of this specification, illustrate one or more embodiments of the present disclosure and, together with the detailed description and examples sections, serve to explain the principles and implementations of the disclosure.

FIG. 1 shows a view of a displaying device which forms part of a trip unit of a circuit breaker.

FIG. 2 shows the displaying device detached from the trip unit.

FIGS. 3A-3E show exemplary schematic layouts of first, second and third displaying regions of the displaying device, together with exemplary displaying features of each of the displaying regions.

FIG. 4 shows exemplary arrangement of push buttons for operating the displaying device.

FIGS. 5A-5B shows exemplary displaying features of the main menu displaying screen of displaying device with a first displaying region showing multiple icons, while a second and third displaying regions show text.

FIG. 6A shows an exemplary navigation through the main menu displaying screens of the displaying device by operating the push buttons.

FIG. 6B show exemplary navigation from the main menu to sub-menus of the displaying device by operating the push buttons.

FIG. 6C shows exemplary navigation through various displaying features of the second and third display regions by operating the push buttons.

FIG. 7A shows exemplary displaying features of the sub-menu displaying screen of the displaying device with one icon together with horizontal text, while the second and third displaying regions show text.

FIGS. 7B-7C show exemplary displaying features of the displaying device, with the first displaying region showing one icon together with horizontal text, while the second and third displaying regions show text.

FIGS. 8A-8B show exemplary displaying features of the displaying device, with the first displaying region showing one icon together with text, the second displaying region showing a bar graph and the third displaying region showing descriptor text contextually related to the bar graph.

FIGS. 9A-9B show exemplary displaying features of the displaying device, with the first displaying region showing one icon together with text, the second displaying showing a waveform plot and the third displaying region showing descriptor text contextually related to the waveform plat.

### DETAILED DESCRIPTION

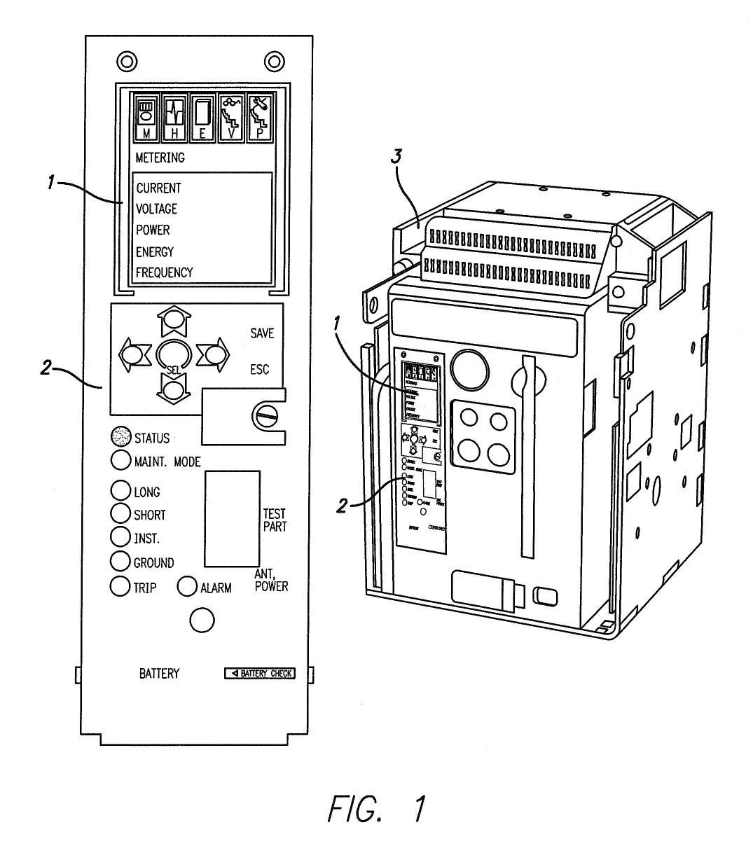

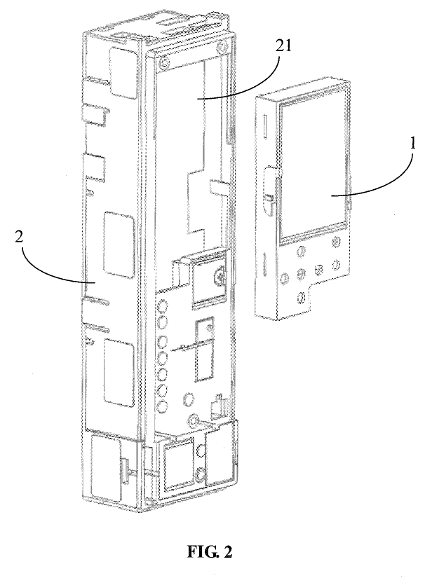

Described herein is a trip unit (2) for a circuit breaker (3) with a displaying device (1) (see FIGS. 1 and 2).

The term “circuit breaker” as used herein indicates an automatically operated electrical switch designed to protect an electrical circuit from damage caused by overload or short circuit. The basic function of a circuit breaker is to detect a fault condition and, by interrupting continuity, to immediately discontinue electrical flow. Conventionally, the circuit breaker includes an operating mechanism, which can be structured to open and close separable electrical contacts, and a trip unit, which can monitor and/or sense system condition and actuate the operating mechanism to a trip position, in order to move the separable contacts to their open position.

The term “icon” as used herein indicates a small picture or symbol serving as a quick, intuitive representation of a software tool, function or a data file accessible on the system.

The term “menu” as used herein with respect to a displaying device indicates a list of commands presented to a user or operator of the device, which provides convenient access to various operations and/or functions of the device, such as metering and plotting data, outputting results, etc. Menus of a system or device are sometimes hierarchically organized, allowing navigation through different levels of the menu structure. For example, selecting a menu entry may expand into a second menu, i.e. a sub-menu, with options related to the selected entry.

The term “text” as used herein with respect to displaying features of a device indicates a constructed combination of alphabetic and numeric characters with simple symbols.

The left panel of FIG. 1 shows an exemplary embodiment of the displaying device (1) as part of a trip unit (2), which may be positioned together or detached from a circuit breaker (3). The right panel of FIG. 1 shows the trip unit (2) positioned inside the circuit breaker (3).

FIG. 2 shows a schematic perspective view of an exemplary embodiment of the displaying device (1) and trip unit (2). The displaying device (1) can be positioned within a chamber (21) of the trip unit (3).

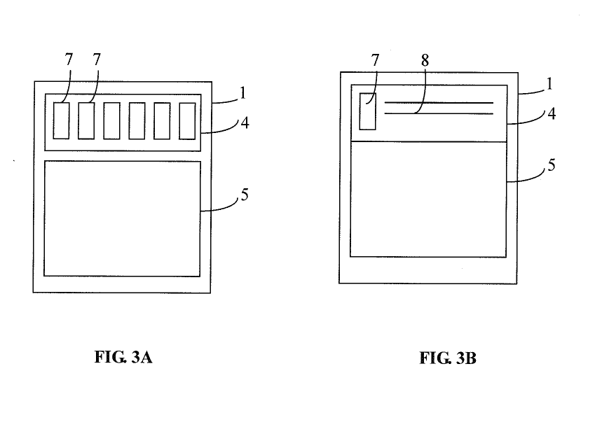

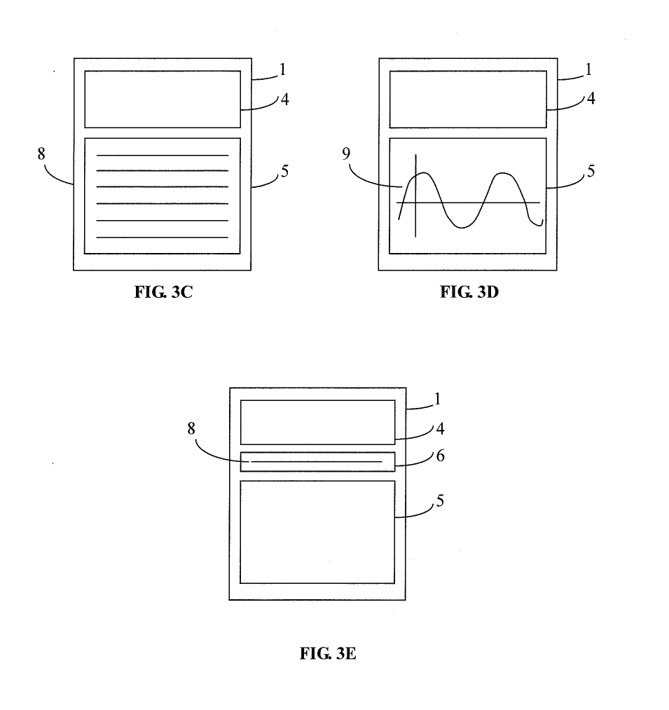

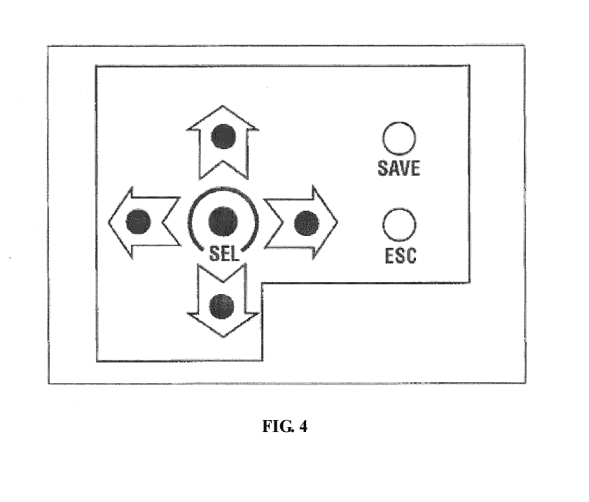

FIGS. 3A-3B show schematic two-dimensional views of the displaying device (1), which comprises a first displaying region (4) and a second displaying region (5). With reference to FIG. 3A, the first displaying region (1) shows a plurality of icons (7) arranged horizontally with respect to one another. With reference to FIG. 3B, the first displaying region (1) shows one icon together with text (8) arranged in one or more horizontal lines.

The second displaying region (5) can show text (8) or graphics (9). In some embodiments, where the second displaying region (5) is adapted to show text (8), the text (8) is arranged in one or more horizontal lines (FIGS. 3C-3D).

According to several embodiments herein described, the displaying device (1) further comprises a third displaying region (6), which is adapted to show text (8) arranged in a horizontal line (FIG. 3E).

FIG. 4 shows an exemplary arrangement of push buttons for operating the displaying device (1) and the trip unit (2). Up and down arrow push buttons are adapted to move up or down a selection in the menu or the sub-menus or to increase or decrease an adjustment value. Right and left push buttons are adapted to move the displaying to a previous or next adjacent display screen. A SAVE button is adapted to save settings or changes to the settings of the displaying device (1) or the trip unit (2). The SAVE button can be covered and protected to deter unauthorized changing or saving of the settings. An ESC (escape) push button is adapted to escape or move back to the previous level of menu displays. A SEL (selection) push button is adapted to select a menu or a parameter.

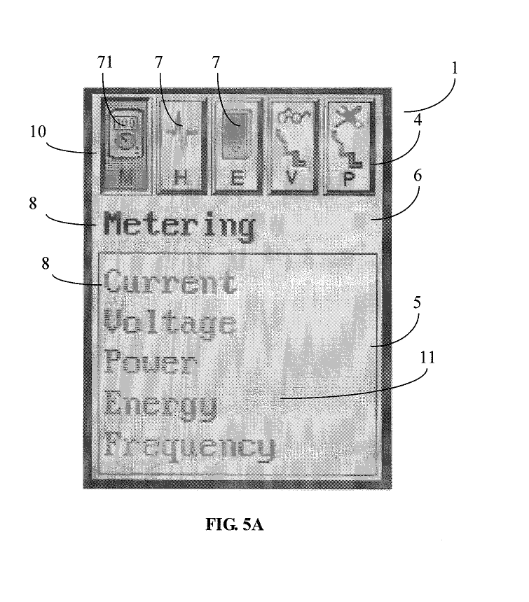

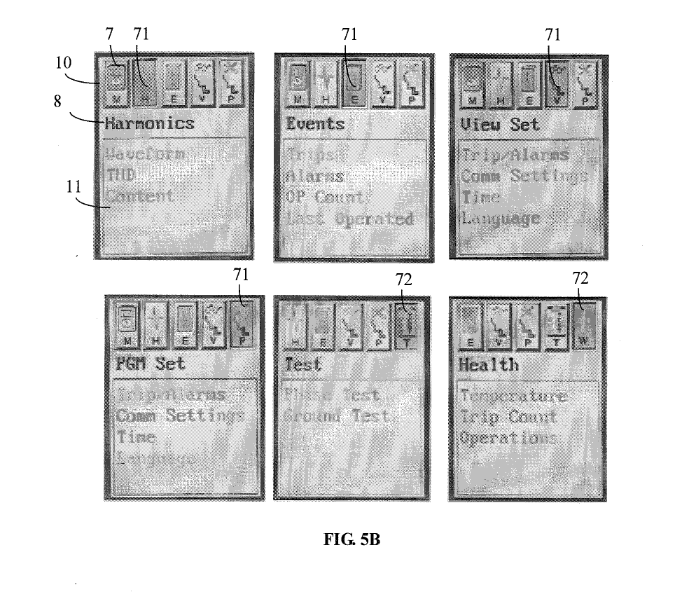

FIG. 5A shows exemplary displaying features of the displaying device (1) when a main menu is shown. In the main menu displaying screen, the first displaying region (4) shows a plurality of icons (7) arranged in a horizontal line, the plurality of icons (7) forms the main menu (10), which comprises a list of functions of the trip unit (2). One of the icons (7) from the menu (10) can be decorated with a different color or shade to distinguish such icon (71) from the remaining icons (7) in order to represent selection of such icon from the menu (10).

As also shown in FIG. 5A, the second displaying region (5) shows a plurality horizontal lines of text (8), which represents a menu including a sub-selection or sub-menu (11) shown in the first displaying region (4).

As further shown in FIG. 5A, the text shown in the third displaying region (6) is contextual to the icon (71) selected in the first displaying region (4). Similarly, the text shown in the second displaying region (5) is contextual to the text shown in the third displaying region (6). In the specific example of the figure, the term “metering” appears as a consequence of the selection of the icon “M”, while the sub-menu comprising the items “Current”, “Voltage”, “Power”, “Energy” and “Frequency” is contextually related to the term “Metering”. Each of the items of the sub-menu can be later selected by the user.

FIG. 5B shows further examples of the main menu displaying screen of the displaying device (1), where a second, third, fourth, fifth and subsequent icons (71) of the plurality of icons (7) shown in the first displaying region (4) are decorated, indicating selection of the function associated to such icons. In particular, upon selecting of a certain icon (71) in the first displaying region (4), the second displaying region (5) shows a sub-menu (11) listing sub-functions of the selected icon (71), and the third displaying region shows a name of the selected icon (71), which is also a name for the sub-menu (11). For example, selection of the third icon “E”, corresponds to selection of the function “Events” in the third displaying region (6), resulting in a user-selectable sub-menu (11) comprised of the sub-functions “Trips”, “Alarms”, “OP Count” and “Last Operated” shown up in the second displaying region (5).

As also shown in FIG. 5B, the number of icons (7) can be higher than the maximum number of icons allowed by the dimension of the icons (7) and the screen. In other words, the display can optionally provide hidden icons that can be shown through horizontal scrolling of the first displaying region (4), as also shown in the last two panels of FIG. 5B, where the hidden icons “T” and “H” are shown.

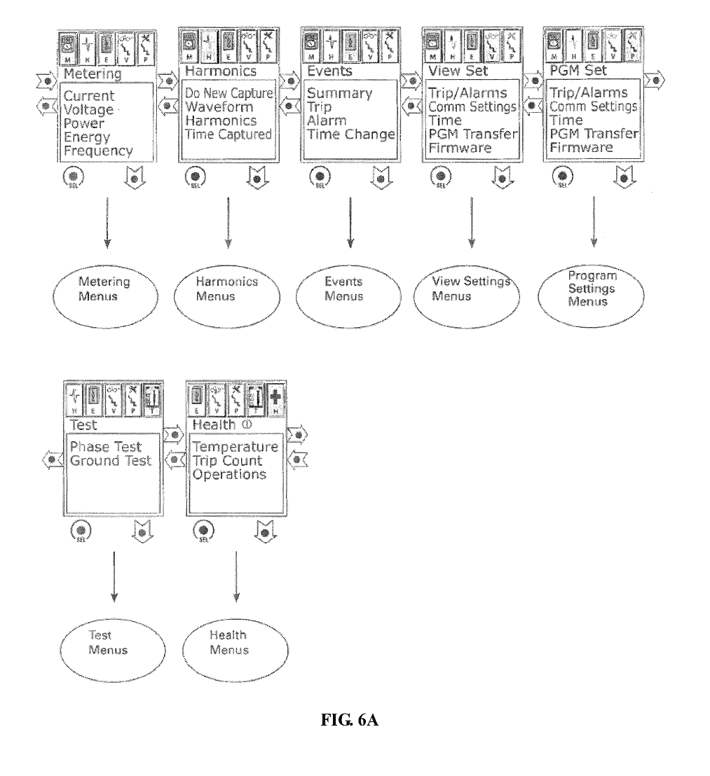

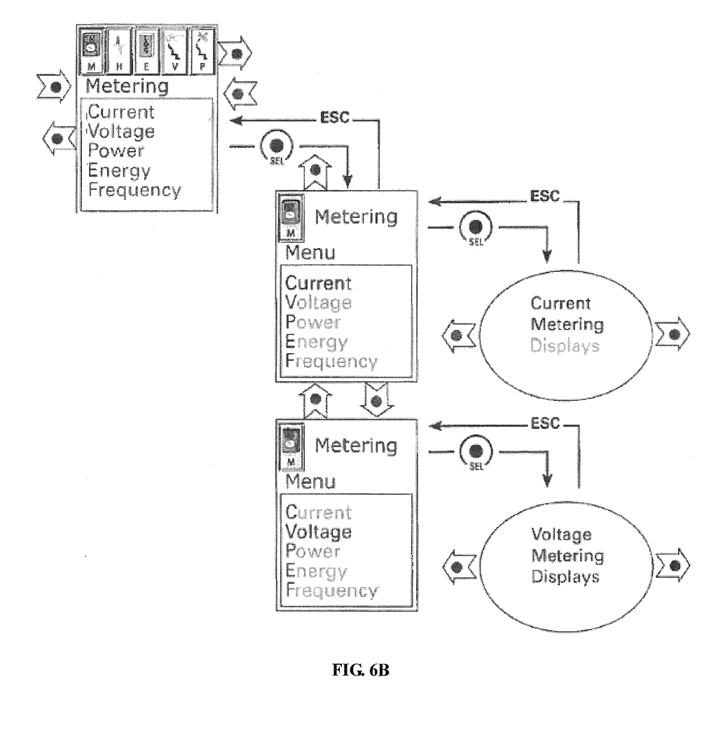

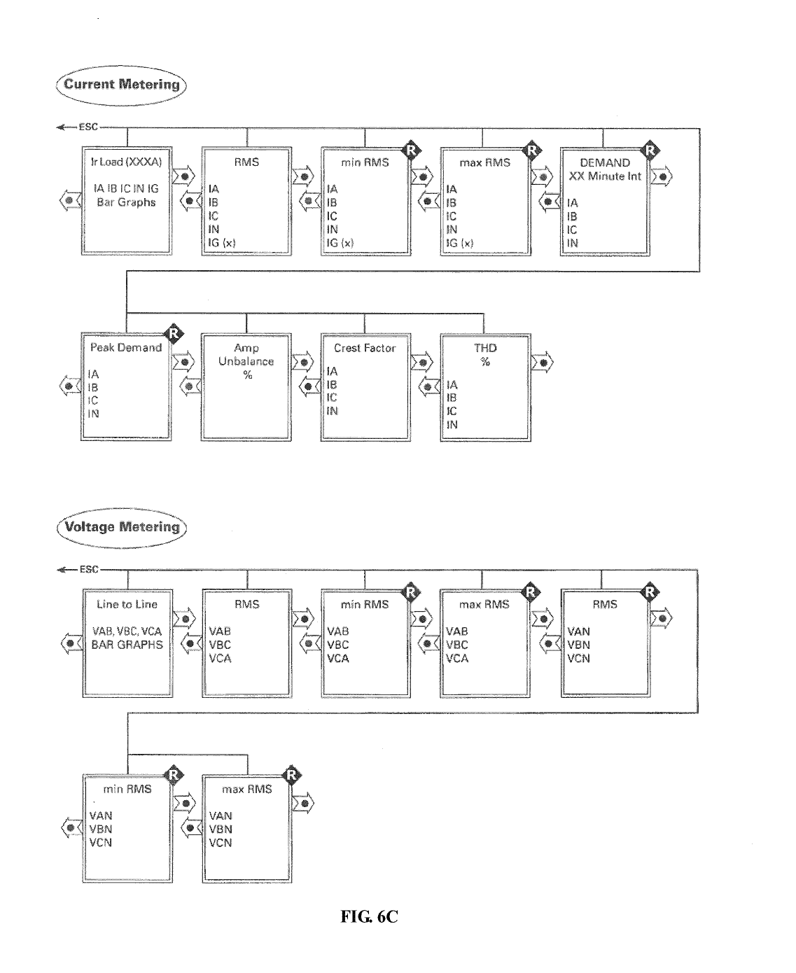

FIG. 6A shows an exemplary navigation through the main menu of the displaying device (1). Particularly, a user may browse the main menu (10) of the plurality of icons (7) by pushing the left or right arrow button, which sequentially highlights one of the icons toward the left or right direction, indicating selection of such icon from the main menu (10). Meanwhile, the second (5) and third (6) displaying regions are updated accordingly with the particular selection of an icon to display, respectively, a sub-menu (11) and descriptor text (81), contextually related to the selected icon (71).

As also shown in FIG. 6A, after an icon is highlighted or selected, a user may give a further selection command to the trip unit (2) by pushing the SEL or down arrow button, which leads to the corresponding sub-menu (11) displaying screen of the selected icon.

FIG. 6B shows an exemplary navigation from the main menu displaying screen to the sub-menu displaying screens. Particularly, after an icon is highlighted or selected from the main menu, pushing the SEL button updates the first displaying region (4) to show the selected icon (71) with descriptor text (8) arranged to the right of the icon. The descriptor text can be arranged in one or more horizontal lines. Meanwhile, the third displaying region (6) is updated to show the text “MENU”, while the second displaying region (5) is updated to show the corresponding sub-menu (11) in a user selectable format. Particularly, in a sub-menu displaying screen, at least one line of text of the sub-menu (11) can be decorated with a different font style, shade and/or color, indicating selection of an item and/or function represented by such line of text from the sub-menu (11). Pushing the up or down arrow button can move the selection up or down through the sub-menu (11). For example, as shown in FIG. 6B, in the top sub-menu displaying screen, the item “Current” is highlighted in bold font. Pushing the down arrow button highlights the next item “Voltage”, as shown in the bottom sub-menu displaying screen.

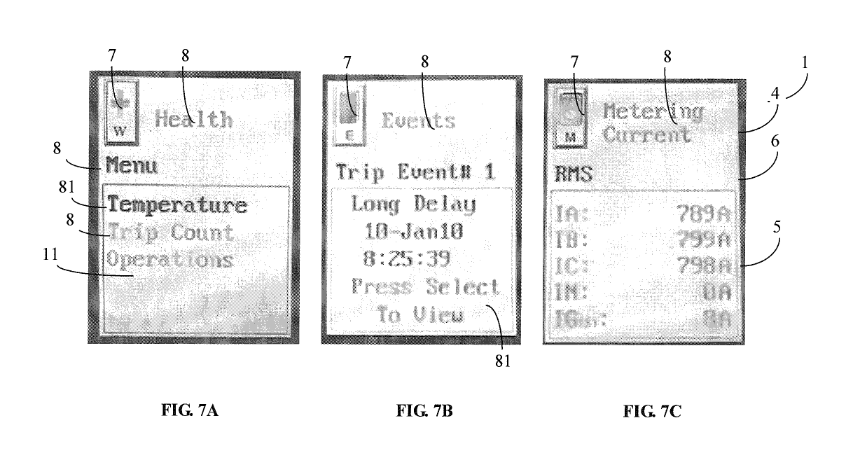

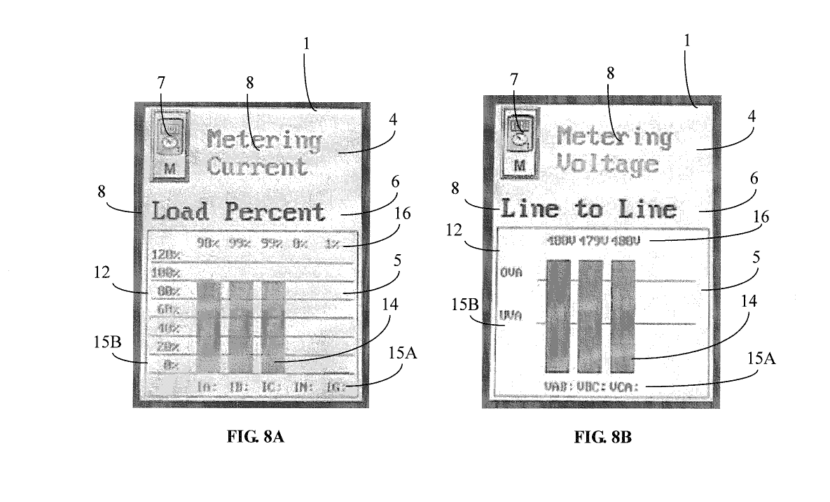

As also shown in FIG. 6B, when an item is highlighted or selected from the sub-menu (11), a user can give further selection command by pushing the SEL button, which directs the displaying device (1) to show various contents of the selected item. Particularly, as soon as the SEL button is pushed, the first displaying region (4) is updated to show the selected icon (71) from the main menu (10) with descriptor text (8) arranged to its right. The descriptor text can have a first line describing the selected icon (71) from the main menu (10) and a second line describing the selected item from the sub-menu (11) (see FIG. 7C and FIGS. 8A and 8B).

FIG. 6C shows exemplary content displayed by the second (5) and third (6) displaying region after the item “Current” is selected from the sub-menu (11) by pushing the SEL button. Particularly, the second displaying region (5) can show text or graphics contextually related to the selected item “Current”, while the third displaying region (6) is updated to show descriptor text of the displayed content in the second displaying region (5).

As also shown in FIG. 6C, a user may browse through the various content that can be shown by the second (5) and third (6) displaying region by pushing the left or right arrow button, which sequentially updates the second and third displaying regions to show a previous or next screen, while the first displaying region is maintained to show the selected icon with the descriptor text.

With continued reference to FIGS. 6A, 6B and 6C, a user may direct the displaying device (1) to go back to a previous menu by pushing the ESC button. For example, pushing the ESC button from the any of the screens as shown in FIG. 6C directs the displaying device (1) to go back to the previous sub-menu displaying screen showing the “Metering” sub-menu, while pushing the ESC button from the “Metering” sub-menu as shown in FIG. 6B directs the displaying device (1) to go back to the main menu displaying screen as shown in FIG. 6A.

FIG. 7A shows exemplary displaying features of the displaying device (1) when a sub-menu (11) is shown. In the sub-menu displaying screen, the first displaying region (4) shows the selected icon “W” (7) and descriptor text “Health” arranged to the right of the icon. The third displaying region (6) shows “Menu” and the second displaying region (5) shows a plurality of lines of text, each line representing an item that can be selected from the sub-menu (11), such as “Temperature”, “Trip Counts” and “Operations”. The item “Temperature” is decorated in bold font, indicating selection of such item.

FIG. 7B shows exemplary displaying features of the displaying device (1) contextually related to the selected item “Trips”. In particular, the first displaying region (4) shows the selected icon “E” and the descriptor text “Events”. The second displaying region (5) shows a plurality of lines of text which indicates a system condition recorded by the trip unit (2). In the particular example of this figure, the second displaying region (5) shows the recorded date and time of a trip event, while the third displaying region (6) shows the descriptor text, “Trip Event #1”, of the recorded trip event.

As further shown in FIG. 7B, the second displaying region (6) also shows two lines of text at the bottom of the displaying region, which indicate that a user may press the SEL button to view more details of the recorded trip event.

With continued reference to FIG. 7B, the first displaying region (4) only shows one line of descriptor text, “Events”, which is contextually related to the selected icon “E”, while the descriptor text “Trips” contextually related to the selected item is not shown. This is an example of text simplification, according to an embodiment herein described, because the descriptor text of third displaying region (6), “Trip Events #1”, in this case is contextually repeating the descriptor text, “Trips”, of the first displaying region (4).

FIG. 7C shows exemplary displaying features of the displaying device (1) contextually related to the selected item “Current”. In particular, the first displaying region (1) shows the selected icon “M” and two lines of descriptor text. The first line, “Metering” is contextually related to the icon, and the second line, “Current”, is contextually related to the selected item. The second displaying region (5) shows a plurality of lines of text, which indicates metered current values by the trip unit (2). Descriptor text “RMS” contextually related to the metered current values is shown in the third displaying region (6).

FIGS. 8A-8B show additional exemplary displaying features of the displaying device (1), wherein the second displaying region (5) is adapted to show a bar graph or chart (12). As shown in FIGS. 8A-8B, the bar graph (12) comprises one or more bars (14), each presenting a value, with lengths of the bars (14) proportional to the value. The bar graph (12) further comprises axes (15) adapted to indicate magnitude and categories of the values. In some embodiments, the bar graph (12) further comprises setpoint limits for the values (16), which allow a user to monitor the status of the system. The values represented by the bars (14) are metered current and/or voltage values by the trip unit (2). The setpoint limits (16) are pre-determined threshold values, wherein when current or voltage values go beyond such threshold, the trip unit (2) alarms or sends a trip signal to the circuit breaker (3).

In particular, with reference to FIG. 8A, the bars (14) represent current values, the x-axis (15A) indicates categories of the current values, which comprise “IA”, “IB”, “IC”, “IN” and “IG”, and the y-axis (15B) indicates magnitude of the current values with a 0%-120% scale. Setpoint limits (16) are shown on the top portion of the bar graph (12). With reference to FIG. 8B, the bars (14) represent voltage values, with the x-axis (15A) indicating categories of the voltage values, which comprise “VAB”, “VBC”, “VCA”, and y-axis (15B) indicating magnitude of the voltage values. Also, setpoint limits (16) are shown on the top portion of the bar graph (12).

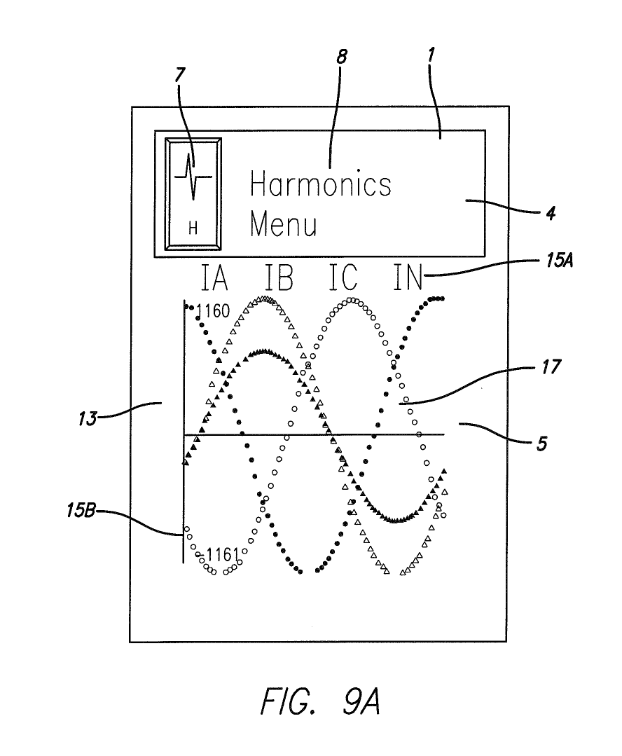

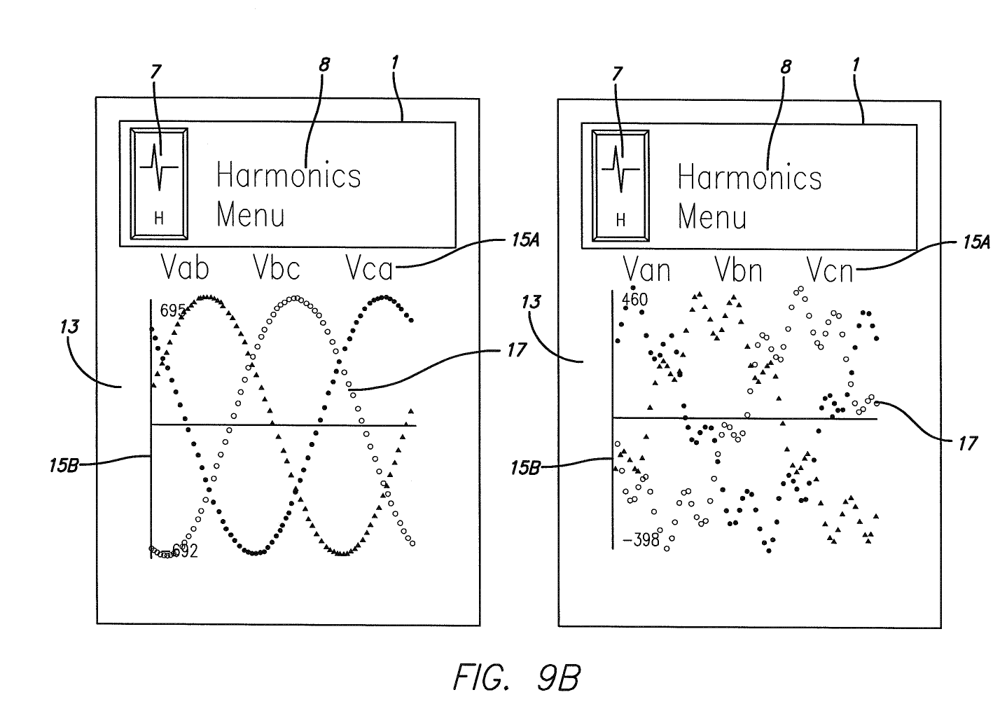

FIGS. 9A-9B show additional exemplary displaying features of the displaying device (1), wherein the second displaying region (5) shows a waveform plot (13). As shown in FIGS. 9A-9B, the waveform plot (13) comprises one or more waveforms (17), each representing a variable. The waveform plot (13) further comprises axes (15) adapted to indicate magnitude and categories of the variables. In some embodiments, the variables represented by the waveforms (17) are current and/or voltage values metered by the trip unit (2).

In particular, with reference to FIG. 9A, four current waveforms (17) are shown in the plot, with the x-axis (15A) indicating categories of the current values, which comprise “IA”, “IB”, “IC” and “IN” and the y-axis (15B) indicating magnitude of the current values. With reference to FIG. 9B, the left and right panels show a waveform plot (13) with three voltage waveforms (17).

Shapes of the one or more waveforms (17) can be delineated by scattered dots. These dots can represent continuous waveforms (FIG. 9B, left panel), or rippled waveforms (FIG. 9B, right panel).

In some embodiments, the waveform plot (13) is adapted to show magnitude and shapes of the one or more waveforms (17) on a cycle-by-cycle basis (FIGS. 9A-9B). Particularly, the trip unit (2) may capture multiple cycles of waveform data for an alarm or trip event, and each cycle is shown individually.

In some embodiments, as shown in FIGS. 9A-9B, the waveform plot (13) is adapted to show harmonics. The term “harmonics” as used herein with respect with an electrical power system, indicates electric voltages and currents that appear on the electric power system as a result of certain kinds of electric loads. Particularly, in a normal alternating current power system, the voltage varies sinusoidally at a specific frequency, typically 50 or 60 hertz. When a linear electrical load is connected to the system, it draws a sinusoidal current at the same frequency as the voltage. When a non-linear load, such as a rectifier, is connected to the system, it draws a current that is not necessarily sinusoidal. The current waveform can become quite complex, depending on the type of load and its interaction with other components of the system. The harmonics feature provides a user with a means to measure the amount of distortion that the circuit breaker and/or the system is experiencing. This can be useful in troubleshooting circuit breaker current loads that could lead to system problems.

As already noted above, color features can be used with reference to any of the text or graph shown in the visual display. For examples, multiple waveforms may be decorated in different colors so that a user can easily distinguish them from one another. Also, alarm or trip events can be shown in red to alert a user of the non-normal condition. In addition, in a setting menu, values that could be changed by a user can be shown in red, while non-changeable, read-only values can be depicted in black.

It is to be understood that the disclosure is not limited to particular embodiments of the displaying device, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications may be made without departing from the spirit and scope of the present disclosure. Accordingly, other embodiments are within the scope of the following claims.

What is claimed is:

1. A trip unit for a circuit breaker, the trip unit comprising a displaying device, the displaying device comprising:
a first displaying region adapted to show a plurality of displaying conditions related to the circuit breaker, the displaying conditions including a first condition where a plurality of user-selectable icons related to the circuit breaker is shown, and a second condition where a selected icon from the plurality of user-selectable icons and text are shown, the text being contextually related to the selected icon; and
a second displaying region adapted to show text or graphics contextually related to the selected icon.

2. The trip unit according to claim 1,
wherein the displaying device further comprises a third displaying region adapted to show text contextually related to the text or graphics shown in the second displaying region.

3. The trip unit according to claim 1, wherein one or more of the plurality of user-selectable icons adapted to be shown by the first displaying region are hidden from view.

4. The trip unit according to claim 3, wherein the one or more hidden user-selectable icons are adapted to be shown by scrolling the first displaying region.

5. The trip unit according to claim 1,
wherein the selected icon is decorated with a different shade or different color from remaining icons of the plurality of user-selectable icons to indicate selection of the selected icon.

6. The trip unit according to claim 1,
wherein the second displaying region is adapted to show a plurality of lines of text; and
wherein at least one line of text of the plurality of lines of text is decorated with a different font style and/or different font color to distinguish said at least one line of text from remaining lines of text of the plurality of lines of text.

7. The trip unit according to claim 6,
wherein the plurality of lines of text shown by the second displaying region forms a sub-menu, and
wherein the decorated at least one line of text represents selection of an item from the sub-menu.

8. The trip unit according to claim 7, wherein the text shown by first displaying region comprises a first line of text contextually related to the selected icon, and a second line of text contextually related to the selected item.

9. The trip unit according to claim 6, wherein the decorated at least one line of text is decorated in bold font.

10. The trip unit according to claim 1, wherein the text of the second displaying region is adapted to show current and/or voltage values of the circuit breaker metered by the trip unit.

11. The trip unit according to claim 1, wherein the text of the second displaying region is adapted to show a status of trip event of the circuit breaker recorded by the trip unit.

12. The trip unit according to claim 1, wherein the second displaying region is adapted to show a bar graph, the bar graph comprising:
one or more bars, each representing a value,
wherein length of a particular bar among the one or more bars is proportional to the value represented by the particular bar, and
axes adapted to indicate magnitudes and/or categories of the represented values.

13. The trip unit according to claim 12, wherein the bar graph further comprises setpoint limits for the values.

14. The trip unit according to claim 12, wherein the values are current and/or voltage values of the circuit breaker metered by the trip unit.

15. The trip unit according to claim 1, wherein the second displaying region is adapted to show a waveform plot, the waveform plot comprising
one or more waveforms, each representing a variable, and
axes adapted to indicate magnitudes and categories of the variables.

16. The trip unit according to claim 15, wherein shapes of the one or more waveforms are delineated by scattered dots.

17. The trip unit according to claim 16, wherein the waveform plot is adapted to show the magnitudes and shapes of the one or more waveforms on a cycle-by-cycle basis.

18. The trip unit according to claim 15, wherein the waveform plot is adapted to show harmonics.

19. The trip unit according to claim 2,
wherein the first displaying region, the second displaying region and the third displaying region are arranged vertically respect to one another,
wherein the first displaying region is arranged above the second and the third displaying regions, and
wherein the third displaying region is arranged above the second displaying region.

20. The trip unit according to claim 1, wherein the displaying device is a color displaying device.
